(19) United States
(12) Patent Application Publication
(10) Pub. No.: US 2026/0111797 A1
(43) Pub. Date: Apr. 23, 2026

(54) METHOD AND APPARATUS FOR KNOWLEDGE DISTILLATION USING TEACHER MODELS

(71) Applicant: UIF (University Industry Foundation), Yonsei University, Seoul (KR)

(72) Inventors: Sung Bae CHO, Seoul (KR); Min Hyuk AN, Seoul (KR)

(73) Assignee: UIF (University Industry Foundation), Yonsei University, Seoul (KR)

(21) Appl. No.: 19/357,336

(22) Filed: Oct. 14, 2025

(30) Foreign Application Priority Data
Oct. 16, 2024 (KR) 10-2024-0141487

(51) Int. Cl. G06N 20/00

(52) U.S. Cl. CPC G06N 20/00

(57) ABSTRACT

In one embodiment, a model learning method includes obtaining a first dataset of classes that a first model can classify and a second dataset of a new class that the first model cannot classify; selecting one old prototypes for each class from the first dataset; performing data augmentation based on the selected old prototypes; embedding the augmented data into an embedding space; embedding data for the new class into the embedding space; performing continual learning of the first model based on embedding results; and training a second model by knowledge distillation based on the continually trained first model.

### CROSS-REFERENCE TO RELATED APPLICATION

This application claims the benefit of Korean Patent Application No. 10-2024-0141487, filed on Oct. 10, 2024, in the Korean Intellectual Property Office, under 35 U.S.C. § 119(a), the entire disclosure of which is incorporated herein by reference in its entirety.

### BACKGROUND

### 1. Field

The disclosure relates to a method for training a model through a knowledge distillation method.

### 2. Discussion of Related Art

Knowledge distillation is a method in which a pre-trained model, called a teacher model, transfers its learned knowledge to a smaller student model. The student model is typically simpler or lighter than the teacher model. This technique is often used for model compression or lightweighting. By training the student model to mimic the teacher model, it is possible to maintain a comparable level of performance while enabling operation under lower computational requirements.

Continual learning is a method of training a previously trained model with new data. Through continual learning, a model can learn from additional data and improve its performance. This approach allows the model to flexibly adapt to changing environments and evolving data.

### SUMMARY

One important problem that occurs during continual learning is a catastrophic forgetting phenomenon. The catastrophic forgetting phenomenon is a phenomenon in which a model forgets previously learned content during continual learning. Various approaches have been proposed to solve such a catastrophic forgetting phenomenon; however, many challenges still remain.

The technology described below intends to solve such a forgetting problem through a knowledge distillation method using two teacher models. However, the technical problems of the disclosure are not limited to the above-described technical problems, and technical problems included within the scope of the disclosure may exist.

### Technical Solution

To achieve the technical problems, the disclosure is to provide a model learning method.

In one embodiment, the model learning method may include: obtaining, by a model learning apparatus, a first dataset including data belonging to classes that the first model can classify and a second dataset including data belonging to a new class that the first model cannot classify; selecting, by the model learning apparatus, old prototypes for each class from the first dataset; performing, by the model learning apparatus, data augmentation based on the selected old prototypes; embedding, by the model learning apparatus, the augmented data into an embedding space; embedding, by the model learning apparatus, data for the new class included in the second dataset into the embedding space; performing, by the model learning apparatus, continual learning of the first model based on results embedded in the embedding space; and training, by the model learning apparatus, a second model by knowledge distillation to learn based on the continually trained first model.

In one embodiment, a model learning apparatus includes a processing unit and a storage device that stores instructions which, when executed by the processing unit, cause the model learning apparatus to perform operations. The operations include: an operation of causing the model learning apparatus to obtain a first dataset including data belonging to classes that the first model can classify and a second dataset including data belonging to a new class that the first model cannot classify; an operation of causing the model learning apparatus to select, from the first dataset, old prototypes for each class; an operation of causing the model learning apparatus to perform data augmentation based on the selected old prototypes; an operation of causing the model learning apparatus to embed the augmented data into an embedding space; an operation of causing the model learning apparatus to embed, into the embedding space, data for the new class included in the second dataset; an operation of causing the model learning apparatus to perform continual learning of the first model based on results embedded in the embedding space; and an operation of causing the model learning apparatus to train a second model by knowledge distillation to learn based on the continually trained first model.

Through the disclosed technique, the forgetting problem that arises during continual learning can be addressed by utilizing two teacher models. In particular, even with a small amount of data, the knowledge of the two teacher models can be effectively transferred, thereby enhancing generalization performance with respect to the data distribution.

Through the disclosed technique, features of a new class can be effectively separated, and the model's generalization performance can be improved by reducing intra-class variance.

Through the disclosed technique, effective learning is possible even with a small amount of data by storing and utilizing only one prototype and one representation per class. In particular, by leveraging the classifier of a previous-task model, optimally augmented prototypes can be employed.

### BRIEF DESCRIPTION OF THE DRAWINGS

FIG. 1 shows one embodiment in which a model learning apparatus (100) performs a model learning method.

FIG. 2 shows, as one embodiment, one example of a model learning method (200).

FIG. 3 shows, as one embodiment, one example of a model learning method.

FIG. 4 shows, as one embodiment, one example of a model learning method.

FIG. 5 shows, as one embodiment, one example of augmenting data.

FIG. 6 shows, as one embodiment, one example showing a change of an embedding space during a continual learning process.

FIG. 7 shows a configuration of one embodiment of a model learning apparatus (300).

### DETAILED DESCRIPTION

The technology described below may be subject to various modifications and may have various embodiments. Specific embodiments of the technology described below may be set forth in the drawings of the specification. However, these are for description of the technology described below and are not intended to limit the technology described below to particular embodiments. Therefore, it should be understood that all modifications, equivalents, or alternatives included within the spirit and technological scope of the technology described below are included in the technology described below.

To describe various components, terms such as first, second, A, and B may be used. However, the above terms are used only to distinguish one component from other components, and are not intended to limit the components by the above terms. For example, without departing from the scope of the technology described below, a first component may be named a second component, and similarly, a second component may be named a first component. The term “and/or” includes a combination of a plurality of related listed items or any one of a plurality of related listed items.

In the terms used below, unless clearly interpreted otherwise in context, singular expressions should be understood to include plural expressions, and terms such as “comprising” should be understood to mean that the specified features, numbers, steps, operations, components, parts, or combinations thereof exist, and should not be understood to exclude the possibility of the existence or addition of one or more other features, numbers, steps, operations, components, parts, or combinations thereof.

Before describing the drawings in detail, it is clarified that the classification of components in this specification is merely a classification by main functions performed by each component. That is, two or more components to be described below may be combined into one component, or one component may be divided into two or more components by more subdivided functions. In addition, each of the components to be described below may additionally perform some or all of the functions performed by other components in addition to the main function it performs, and, of course, some functions among the main functions performed by each component may be exclusively performed by other components.

Also, in performing a method or an operation method, unless a specific order is clearly described in context for each process constituting the method, the processes may occur in an order different from the described order. That is, each process may occur in the same order as described, may be performed substantially simultaneously, or may be performed in the reverse order.

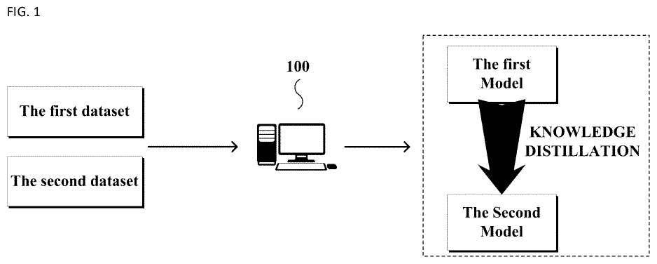

As used herein, the term “module” denotes a structural software and/or hardware component implemented by one or more processors executing program instructions stored in memory and having specific internal layers/blocks and parameters. Examples include an embedding layer (e.g., normalization→projection→normalization), a prototype generator (e.g., feature aggregator and mean/vector calculator), and a classifier head (e.g., fully-connected layers with softmax). Unless stated otherwise, the modules described herein are implemented as concrete network layers/blocks executed by processors, rather than as generic “means.” FIG. 1 shows one embodiment in which a model learning apparatus (100) performs a model learning method.

The model learning apparatus (100) may be implemented in various physical forms. For example, the model learning apparatus (100) may take the form of a PC, a notebook, a smart device, a server, or a chipset dedicated to data processing.

The model learning apparatus (100) may exist as at least one. That is, the model learning method may be performed by one model learning apparatus or may be divided and performed by at least one apparatus.

The model learning apparatus (100) may be an apparatus that performs a model learning method. The model learning apparatus (100) may obtain a first dataset and a second dataset. The first dataset may include data used when training a first model. The first dataset may include data belonging to classes that the first model can classify. The second dataset may include new data not used when training the first model. The second dataset may include data of a class that the first model cannot classify. The model learning apparatus (100) may build a second model by knowledge distillation of the first model. The first model may be a model continually trained to classify a new class through second data. As described later, the second model may be trained through a knowledge distillation method using two teacher models (Feature Extractor, Classifier) included in the first model.

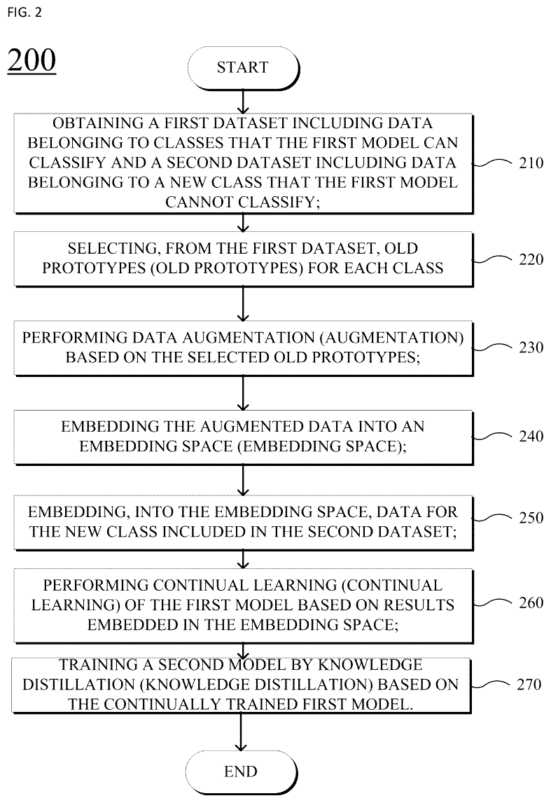

FIG. 2 shows, as one embodiment, one example of a model learning method (200).

A model learning apparatus may obtain a first dataset including data belonging to classes that the first model can classify (210) And a model learning apparatus may obtain a second dataset including data belonging to a new class that the first model cannot classify (210).

In one example, the first model may be a trained model trained based on training data. The first model may be a model based on machine learning (Machine Learning, ML). The first model may be a model based on artificial intelligence (Artificial Intelligence, AI). The first model may be various types of models. The first model may include RF (random forest), KNN (k-nearest neighbor), Naive Bayes, SVM (support vector machine), and ANN (artificial neural network). An ANN may be a DNN (Deep Neural Network), which may include a CNN (Convolutional Neural Network), an RNN (Recurrent Neural Network), an RBM (Restricted Boltzmann Machine), a DBN (Deep Belief Network), and a GAN (Generative Adversarial Network), RN (Relation Networks).

In one example, the first model may be a pre-trained (Pre Training) model. The first model may be a model trained based on the first dataset. The first dataset may be a dataset used to train the first model.

In one example, the first model may be a classification model. The first model may be a model that classifies data into one of a plurality of classes.

In one example, the first model may be a model that extracts features from data. The first model may extract features from data and classify data based on the extracted features. The first model may include a feature extractor and a classifier. The first model may include an embedding module that embeds the extracted features into an embedding space. The first model may be a model that extracts features from data, embeds the extracted features into an embedding space, and classifies data based on an embedded result.

In one example, the first dataset may be data used when training the first model. The first dataset may include data belonging to classes that the first model can classify. For example, if the first model is a model that classifies image data into puppy or dog, the first dataset may include puppy image data and dog image data.

In one example, the second dataset may be data not used when training the first model. The second dataset may include data of a new class that the first model cannot classify. For example, if the first model is a model that classifies image data into puppy or dog, the first dataset may include goat image data or sheep image data.

A model learning apparatus may select, from the first dataset, old prototypes for each class (220).

In one example, an old prototypes may be data representing each class. An old prototypes may be data including representative features of each class. An old prototypes may be data that, when data belonging to each class are embedded into an embedding space, are located at the center of each class in the embedding space. An old prototypes may be data closest to an average when the average of data belonging to each class in the embedding space is taken.

In one example, an old prototypes may exist for each class. For example, if three classes exist in the first dataset, old prototypes may exist for each of the three classes.

A model learning apparatus may perform data augmentation based on selected old prototypes (230).

In one example, data augmentation may include a process of generating data belonging to the same class as the old prototypes.

In one example, data augmentation may include a process of augmenting data so that data belonging to the same class can be located at a close distance from each other on an embedding space. Data augmentation may include a process of generating data that can be located within a certain range of an old prototypes on an embedding space. Conversely, data augmentation may include a process of generating data that can be located at a far distance from data of a new class on an embedding space.

In one example, data augmentation may include a process of generating data by reflecting a trainable parameter vector in a result of embedding an old prototypes. A trainable parameter vector may have a certain direction and magnitude. The direction and magnitude of the trainable parameter vector may be modified during a training process. For example, a trainable parameter vector may be modified such that an embedding result of augmented data can be located within a certain distance(threshold distance) of an embedding result of an old prototypes.

A model learning apparatus may embed augmented data into an embedding space (240).

In one example, embedding refers to representing data as numeric vectors that capture the semantics of the data and relationships among data items.

In one example, an embedding space may be a space in which embedded data are located. In an embedding space, data that have similar meanings or are related to each other may be located close to each other. Conversely, in an embedding space, data that have dissimilar meanings or are not related to each other may be located far from each other.

In one example, in an embedding space, there may exist a result of embedding an old prototypes, a result of embedding augmented data, and a result of embedding data for a new class included in a second dataset. As such, since various data may be embedded in an embedding space, the embedding space may be referred to as a joint embedding space.

In one example, an embedding space may be used when a second model is learned from a first model through knowledge distillation. For example, a second model may be trained to generate an embedding space similar to the first model.

In one example, in an embedding space, data having the same class may be located within a certain distance or within a certain region from each other. In an embedding space, data having the same class may be located so that variance between them is reduced. For example, since augmented data belong to the same class as old prototypes, the two may be located within a certain range of each other. Conversely, since data for a new class included in a second dataset have a class different from an old prototypes, the two may be located in different ranges.

A model learning apparatus may embed, into an embedding space, data for a new class included in a second dataset (250).

In one example, a model learning apparatus may extract features from data for a new class included in the second dataset and map the extracted features into an embedding space. For this, an embedding module may be used.

In one example, data for a new class may be embedded so as to be located at a far distance from augmented data.

A model learning apparatus may continually learn a first model based on results embedded in an embedding space (260).

In one example, continual learning may include continually training the first model so that the first model can additionally classify a new class. Continual learning may include a process of adjusting parameters of a classifier included in the first model so that the first model can additionally classify a new class. Continual learning may include a process of adjusting parameters of an embedding module included in the first model so that data belonging to different classes can be located at different positions in an embedding space. Continual learning may include a process of setting a new decision boundary in an embedding space so that a new class can be additionally classified.

A model learning apparatus may train a second model by knowledge distillation based on the continually trained first model (270).

In one example, a model learning apparatus may train a second model to extract features similar to the first model. A model learning apparatus may train a second model to generate embedding results similar to the first model. A model learning apparatus may train a second model to have classification results similar to the first model.

In one example, a second model may be a model having a relatively smaller size than the first model. A second model may be a model having relatively fewer parameters than the first model. A second model may be a model having relatively fewer layers than the first model.

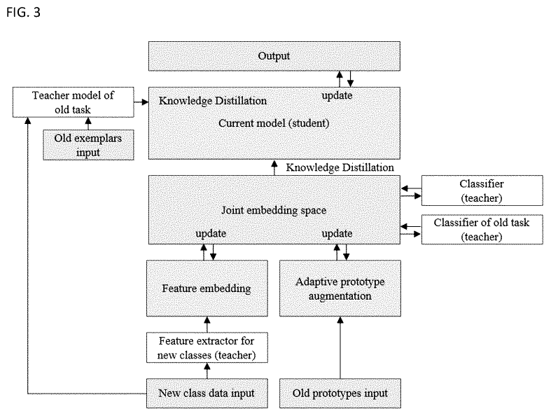

FIG. 3 shows, as one embodiment, one example of a model learning method.

FIG. 3 shows an overall structure of the present disclosure in which, based on a teacher model and an input corresponding to an existing task, adaptive prototype augmentation is performed, features of a new class are embedded into a joint embedding space, and then a continual learning model receives knowledge distillation to learn a new task while retaining knowledge of an existing task.

As in FIG. 3, to solve specified technical problems, an adaptive prototype augmentation unit, a feature embedding unit, and a knowledge distillation unit may be included.

An adaptive prototype augmentation unit may receive, per class of a previous task, one old prototypes. An adaptive prototype augmentation unit may use a trainable parameter vector for data augmentation. A trainable parameter vector may be optimized through a classifier of an existing task model(Classifier of old task). An adaptive prototype augmentation unit may perform data augmentation based on an old prototypes and may update the results performed by embedding them into a joint embedding space (Joint Embedding Space).

A feature embedding unit may update a joint embedding space by embedding features extracted by a pre-trained teacher model. At this time, features extracted from data belonging to different classes may be embedded so as to be located far from each other. Through this, inter-class classification performance may be improved. At the same time, an embedded data distribution may be adjusted to be located close to a class center so as to be better generalized by reducing intra-class variance.

A knowledge distillation unit may allow a student model to be learned by performing knowledge distillation based on an updated joint embedding space. Through this, a student model may efficiently learn a feature distribution of an existing task and features for a new task.

Such components are combined as a whole so that a continual learning model can effectively learn features of a new class while minimizing forgetting of existing knowledge.

Through this, data efficiency can be increased, and high classification performance and generalization ability with respect to an existing task and a current task can be maintained.

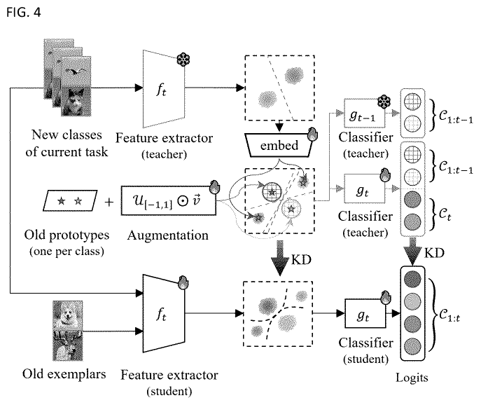

FIG. 4 shows, as one embodiment, one example of a model learning method.

In the embodiment of FIG. 4, a first model and a second model may include a feature extractor that extracts features from an image and a classifier that classifies an image based on the extracted features. As in FIG. 4, a second model may be built by knowledge distillation of two teacher models included in the first model, namely, a feature extractor and a classifier.

From previous data used to train a model, one data (so-called, old prototypes) per class may be selected. That is, to continually train a first model, old prototypes per two classes included in a first dataset may be selected.

Data augmentation may be performed based on the selected old prototypes. Data augmentation may be parameterized by a trainable parameter vector The trainable parameter vector may be updated during a continual learning process.

Augmented data may be embedded into an embedding space. On an embedding space, augmented data may be located within a certain distance around an old prototypes.

A teacher feature extractor(teacher) may be pre-trained. That is, a teacher feature extractor may be included in a first model.

A pre-trained teacher feature extractor may extract features from data belonging to a new class (New classes of current task) regarding a current task. That is, a teacher feature extractor may extract features from data included in a second dataset.

Features extracted from a new class may be embedded into an embedding space as with the augmented data described above. For this, an embedding module (Embed) may be used. At this time, features belonging to different classes may be embedded to be far apart, and features belonging to the same class may be embedded to be close. Through this, inter-class classification performance may be improved. At the same time, an embedded data distribution may be located close to a class center. Through this, it may be possible to reduce intra-class variance so as to be better generalized. For this, an embedding module may be trained so that embedding may be made clearer during a continual learning process.

A teacher classifier (Classifier (teacher)) is trained to classify a new class based on an embedding distribution in the embedding space described above. That is, a teacher classifier may be continually learned based on embedded results. For example, as in FIG. 4, a teacher classifier, which was able to classify data into one of two classes (C_{1:t-1}) (gₜ₋₁), may subsequently be trained to classify data into one of four classes (C_{1:t-1}, Cₜ) (gₜ). For example, as in FIG. 4, a teacher classifier may be trained to classify a new class by adding a decision boundary for classifying a new class to a decision boundary for classifying an old prototypes.

A student feature extractor(Feature Extractor (student)) and a student classifier (Classifier (student)) may be learned by receiving knowledge distillation (KD) from a continually learned model. That is, a student feature extractor and a student classifier may be a second model. A student feature extractor may extract features from data included in first data or data included in second data. A student feature extractor may extract features from exemplars for previous classes (Old exemplars) or from data for a new class of a current task. A student feature extractor may be trained to extract features similar to results in which the first model extracted features. Extracted features may be embedded into an embedding space. An embedding result may be similar to a result embedded by the first model. A student feature extractor may be trained to be embedded similar to a result embedded by the first model. A student classifier may classify data based on embedded results. A student classifier may be trained to classify images similar to results classified by the first model.

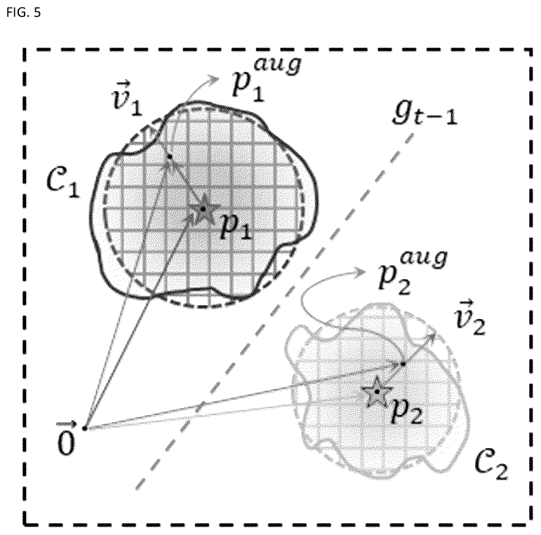

FIG. 5 shows, as one embodiment, one example of augmenting data.

Old prototypes (p1, p2) belonging to different selected classes may be embedded into an embedding space. Old prototypes belonging to different classes may be distinguished through an initial decision boundary (gₜ₋₁). Data may be augmented (p1_{aug}, p2_{aug}) by using trainable parameter vectors (v1, v2) for old prototypes in an embedding space. A trainable parameter vector may have a direction and a magnitude. The direction and magnitude of a trainable parameter vector may be learned during a training process. A trainable parameter vector may be optimized during a continual learning process. A trainable parameter vector may be optimized through a teacher classifier.

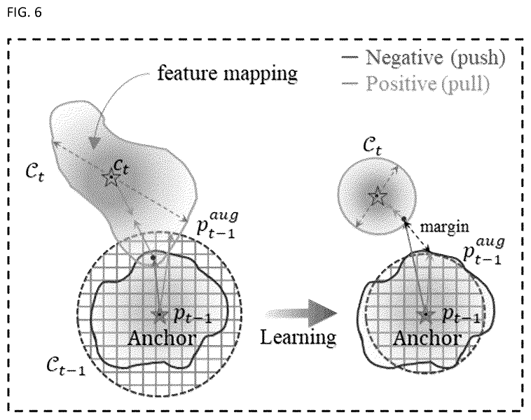

FIG. 6 shows, as one embodiment, one example showing a change in an embedding space during a continual learning process.

In FIG. 6, C₁ may be a region when data for a new class are embedded. In FIG. 6, Cₜ₋₁ may be a region when augmented data (pₜ₋₁^{aug}) are embedded based on an old prototypes (pₜ₋₁). In summary, Cₜ₋₁ is a class that a model can classify before continual learning, and Cₜ may be a class that a model can newly classify after continual learning.

Before continual learning, C₁ and Cₜ₋₁ have overlapping regions. Therefore, it is not easy to distinguish data belonging to a new class and data belonging to an existing class.

During a continual learning process, data belonging to a new class (C₁) and data belonging to an existing class (Cₜ₋₁) may be learned to move farther apart (Negative (Push)). During a continual learning process, data (C_{t, t-1}) belonging to the same class may be learned to move closer together (Positive (Pull)).

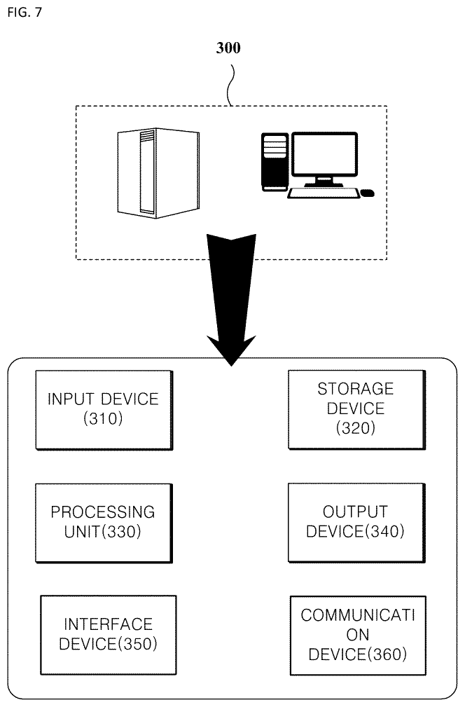

FIG. 7 shows a configuration of one embodiment of a model learning apparatus (300).

The model learning apparatus (300) may correspond to the model learning apparatus (100) described above with reference to FIG. 1 and the like. That is, the model learning apparatus (300) may be an apparatus that performs the model learning method described above. The model learning apparatus (300) may include at least one input device (310), a storage device (320), a processor (330), an output device (340), an interface device (350), and a communication device (360).

The input device (310) may receive data, information, models, or the like necessary to perform the model learning method described above. The input device (310) may receive first training data and second training data. The input device (310) may receive a first model and a second model. The input device (310) may receive training data necessary to train a first model and a second model. The input device (310) may include a device (keyboard, mouse and touchscreen, joystick, trackball, touchpad, scanner, webcam, etc.) that inputs certain commands or data. The input device (310) may include a configuration of receiving data through a separate storage device (USB, CD, hard disk, etc.). The input device (310) may receive data through a separate measuring device or a separate database. The input device (310) may receive data via a communication device (360) by wire or wirelessly. The input device (310) may receive a control signal to control the model learning apparatus (300).

The storage device (320) may store data, information, models, or the like necessary to perform the model learning method described above. The storage device (320) may store first training data and second training data. The storage device (320) may store a first model and a second model. The storage device (320) may store training data necessary to train a first model and a second model. The storage device (320) may be a device that stores certain data, information, models, or the like. The storage device (320) may store data, information, models, or the like input through the input device (310). The storage device (320) may store instructions that cause the processor (330) to perform operations necessary for a model learning method. The storage device (320) may store information generated during an operation by the processor (330). That is, the storage device (320) may include a memory. For example, the storage device may include an HDD (Hard Disk Drive), an SSD (Solid State Drive), a ROM, a RAM, and a CD-ROM, a magnetic tape, or a floppy disk.

The processor (330) may perform computations necessary to perform the model learning method described above. The processor (330) may obtain a first dataset including data belonging to classes that the first model can classify and a second dataset including data belonging to a new class that the first model cannot classify. The processor (330) may select, from the first dataset, old prototypes (Old prototypes) for each class. The processor (330) may perform data augmentation (Augmentation) based on selected old prototypes. The processor (330) may embed augmented data into an embedding space (Embedding Space). The processor (330) may embed, into an embedding space, data for a new class included in a second dataset. The processor (330) may continually learn a first model based on results embedded in an embedding space. The processor (330) may learn a second model by knowledge distillation based on a continually learned first model.

The processor (330) may be a device that processes data and performs certain computations, such as a processor (Processor), an AP (Application Processor), or a chip on which a program is embedded. For example, the processor (330) may include a CPU (Central Processing Unit), a GPU (Graphics Processing Unit), or an NPU (Neural Processing Unit). The processor (330) may generate a control signal for controlling the model learning apparatus (300). The processor (330) may generate control signals for controlling the input device (310), the storage device (320), the output device (340), the interface device (350), and the communication device (360) included in the model learning apparatus (300).

The output device (340) may be a device that outputs certain data, information, and models. The output device (340) may be a device that outputs certain data, information, and models to the outside of the model learning apparatus (300). The output device (340) may output interfaces necessary for a data processing process, input data, analysis results, and the like. The output device (340) may include devices that output data through tactile, visual, auditory, gustatory, and olfactory methods. The output device (340) may be implemented in various physical forms such as a display, a speaker, a vibration motor, or a document output device. The output device (340) may output data, information, or models stored in the storage device (320). The output device (340) may output data, information, and models generated during an operation by the processor (330). The output device (340) may output results computed by the processor (330).

The interface device (350) may be a device that receives certain commands and data from outside. The interface device (350) may receive a control signal to control the model learning apparatus (300). The interface device (350) may output results analyzed by the model learning apparatus (300). The interface device (350) may receive information necessary to perform the model learning method described above from a physically connected input device or an external storage device.

The communication device (360) may receive information necessary to perform the model learning method described above. The communication device (360) may receive a model necessary to perform the model learning method described above. The communication device (360) may transmit and receive first training data and second training data. The communication device (360) may transmit and receive a first model and a second model. The communication device (360) may receive a control signal necessary to control the model learning apparatus (300). The communication device (360) may transmit results analyzed by the model learning apparatus (300). The communication device (360) may mean a configuration that receives and transmits certain data, information, and models through a wired or wireless network. The communication device (360) may perform network communication such as Wi-Fi (Wireless Fidelity), Wi-Fi Direct, Bluetooth, UWB (Ultra-Wide Band) or NFC (Near Field Communication), USB (Universal Serial Bus), or HDMI (High Definition Multimedia Interface), LAN (Local Area Network).

The model learning method described above may be implemented as a program (or application) including an executable algorithm that can be executed on a computer.

The program may be stored and provided on a transitory or non-transitory computer-readable medium (non-transitory computer readable medium)

The transitory computer-readable medium refers to various RAM, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synclink DRAM (SLDRAM), and a Direct Rambus RAM (DRRAM).

The non-transitory computer-readable medium means a medium that stores data semi-permanently, rather than a medium that stores data for a short moment such as a register, a cache, or a memory, and that is readable by a device. Specifically, the various applications or programs described above may be stored and provided on a non-transitory computer-readable medium such as a CD, a DVD, a hard disk, a Blu-ray disc, a USB, a memory card, a ROM (read-only memory), a PROM (programmable read only memory), an EPROM (Erasable PROM, EPROM) or an EEPROM (Electrically EPROM), or a flash memory.

This embodiment and the drawings attached to this specification merely clearly show a part of the technical ideas included in the above-described technology, and it will be obvious that modifications and specific embodiments that can be easily inferred by those skilled in the art within the scope of the technical ideas included in the specification and drawings of the above-described technology are all included in the scope of rights of the above-described technology.

What is claimed is:

1. A model learning method comprising:
obtaining, by a model learning apparatus, a first dataset including data belonging to classes that a first model can classify and a second dataset including data belonging to a new class that the first model cannot classify;
selecting, by the model learning apparatus, old prototypes for each class from the first dataset;
performing, by the model learning apparatus, data augmentation based on the selected old prototypes;
embedding, by the model learning apparatus, the augmented data into an embedding space;
embedding, by the model learning apparatus, data for the new class included in the second dataset into the embedding space;
performing, by the model learning apparatus, continual learning of the first model based on results embedded in the embedding space; and
training, by the model learning apparatus, a second model by knowledge distillation based on the continually trained first model;

2. The method of claim 1,
wherein the first model comprises a feature extractor configured to extract features from data, an embedding module configured to embed the extracted features into the embedding space, and a classifier configured to classify data based on an embedding result;

3. The method of claim 1,
wherein the old prototypes are data that, when data belonging to each class are embedded into the embedding space, are located at centers of the respective classes in the embedding space;

4. The method of claim 1,
wherein the data augmentation comprises generating data that can be located within a threshold distance from the old prototypes in the embedding space;

5. The method of claim 1,
wherein the data augmentation comprises a process of generating data by reflecting a trainable parameter vector in an embedding result of the old prototypes;

6. The method of claim 1,
wherein the continual learning comprises continually training the first model so that the first model can additionally classify a new class;

7. The method of claim 1,
wherein the continual learning comprises adjusting parameters of a classifier included in the first model so that the first model can additionally classify a new class, and adjusting parameters of an embedding module included in the first model so that data belonging to different classes can be located at different positions in the embedding space;

8. The method of claim 1,
wherein the knowledge distillation comprises training the second model to generate embedding results similar to the first model and training the second model to have classification results similar to the first model;

9. A model learning apparatus comprising a processing unit and a storage device including instructions which, when executed by the processing unit, cause the model learning apparatus to perform operations,
the operations comprising:
an operation of causing the model learning apparatus to obtain a first dataset including data belonging to classes that a first model can classify and a second dataset including data belonging to a new class that the first model cannot classify;
an operation of causing the model learning apparatus to select, from the first dataset, old prototypes for each class;
an operation of causing the model learning apparatus to perform data augmentation based on the selected old prototypes;
an operation of causing the model learning apparatus to embed the augmented data into an embedding space;
an operation of causing the model learning apparatus to embed, into the embedding space, data for the new class included in the second dataset;
an operation of causing the model learning apparatus to perform continual learning of the first model based on results embedded in the embedding space; and
an operation of causing the model learning apparatus to train a second model by knowledge distillation (Knowledge Distillation) based on the continually trained first model;

10. The model learning apparatus of claim 9,
wherein the first model comprises a feature extractor configured to extract features from data, an embedding module configured to embed the extracted features into the embedding space, and a classifier configured to classify data based on an embedding result;

11. The model learning apparatus of claim 9,
wherein the old prototypes are data that, when data belonging to each class are embedded into the embedding space, are located at centers of the respective classes in the embedding space;

12. The model learning apparatus of claim 9,
the data augmentation comprises generating data that can be located within a threshold distance from the old prototypes in the embedding space;

13. The model learning apparatus of claim 9,
wherein the data augmentation comprises a process of generating data by reflecting a trainable parameter vector in an embedding result of the old prototypes;

14. The model learning apparatus of claim 9,
wherein the continual learning comprises continually training the first model so that the first model can additionally classify a new class;

15. The model learning apparatus of claim 9,
wherein the continual learning comprises adjusting parameters of a classifier included in the first model so that the first model can additionally classify a new class, and adjusting parameters of an embedding module included in the first model so that data belonging to different classes can be located at different positions in the embedding space;

16. The model learning apparatus of claim 9,
wherein the knowledge distillation comprises training the second model to generate embedding results similar to the first model and training the second model to have classification results similar to the first model;
